(19) United States
(12) Patent Application Publication
(10) Pub. No.: US 2015/0277996 A1
(43) Pub. Date: Oct. 1, 2015

(54) NOTIFICATION OF AN IDLE COMPUTING SYSTEM

(71) Applicant: International Business Machines Corporation, Armonk, NY (US)

(72) Inventors: Judith H. Bank, Cary, NC (US); Lisa M. Bradley, Cary, NC (US); Aaron J. Quirk, Cary, NC (US); Lin Sun, Morrisville, NC (US)

(73) Assignee: International Business Machines Corporation, Armonk, NY (US)

(21) Appl. No.: 14/230,063

(22) Filed: Mar. 31, 2014

(51) Int. Cl. G06F 9/54

(52) U.S. Cl. CPC G06F 9/542; G06F 9/546

(57) ABSTRACT

A computer-implemented method for system notification of a computing system, is provided. The computer implemented method comprises, detecting, via a sensor, if a user of a computing system is in proximate distance to the computing system is provided. The computer-implemented method further comprises, calculating the user's estimated return time to the computing system, wherein the user's estimated return time to the computing system is based on calendaring information, or system usage pattern of the user of the computing system. The computer-implemented method further comprises intercepting an existing notification of the computing system, wherein the existing notification is intercepted when the user moves away from the computing system. The computer-implemented method further comprises intensifying a new, non-existing notification of the computing system, based on the calculated user's estimated return time, and the detected proximate distance.

### BACKGROUND

The present invention relates generally to computing systems, and more particularly to notification of a missed call, or a missed mobile instant message of a computing system, during idle periods of the computing system, and when a user of the computing system is in proximate distance to the computing system.

The Information Age, also known as the Digital Age or Computer Age is characterized by the ability to generate, process, transfer, and share information in a negligible amount of time. Further, wireless communication services conducted over the internet, on a network of computing systems, have played an important role in technical progression of the Information Age. Also, wireless communication services, including, for example, mobile computing devices, or computers, have the ability to transfer wireless communication, such as, mobile instant messages, using short message service (SMS) between mobile computing devices.

### SUMMARY

According to one embodiment of the present invention, a computer-implemented method for system notification of a computing system is provided. The computer-implemented method comprises detecting, by one or more processors, via a sensor, if a user of a computing system is in proximate distance to the computing system. Further, when the user moves away from the computing system, the computer-implemented method further comprises, calculating, by the one or more computers, the user's estimated return time to the computing system, wherein the user's estimated return time to the computing system is based on calendaring information, or system usage pattern of the user of the computing system. The computer-implemented method further comprises intercepting, by the one or more processors, an existing notification of the computing system, wherein the existing notification is intercepted when the user moves away from the computing system. The computer implemented method further comprises intensifying, by the one or more processors, a new, non-existing notification of the computing system, based on the calculated user's estimated return time, and the detected proximate distance.

According to another embodiment of the present invention, a computer system for system notification of a computing system is provided. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to detect, via a sensor, if a user of a computing system is in proximate distance to the computing system. The computer system further comprises program instructions to calculate the user's estimated return time to the computing system, when the user moves away from the computing system, wherein the user's estimated return time to the computing system is based on calendaring information, or system usage pattern of the user of the computing system. The computer system further comprises program instructions to intercept an existing notification of the computing system, wherein the existing notification is intercepted when the user moves away from the computing system. The computer system further comprises program instructions to intensify a new, non-existing notification of the computing system, based on the calculated user's estimated return time, and the detected proximate distance.

According to yet another embodiment of the present invention, a computer program product for system notification of a computing system is provided. The computer program product comprises, one or more processors, one or more computer-readable memories, one or more computer-readable tangible storage devices and program instructions which are stored on at least one of the one or more storage devices for execution by at least one of the one or more processors via at least one of the one or more memories is provided. The computer program product comprises program instructions to detect, via a sensor, if a user of a computing system is in proximate distance to the computing system. The computer program product further comprises program instructions to calculate the user's estimated return time to the computing system, when the user moves away from the computing system, wherein the user's estimated return time to the computing system is based on calendaring information, or system usage pattern of the user of the computing system. The computer program product further comprises program instructions to intercept an existing notification of the computing system, wherein the existing notification is intercepted when the user moves away from the computing system. The computer program product further comprises program instruction to intensify a new, non-existing notification of the computing system, based on the calculated user's estimated return time, and the detected proximate distance.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 is a system notification environment for notifying a user of one or more computing devices of a missed call, or a missed SMS message of the one or more computing devices, in accordance with embodiments of the present invention

FIG. 2 is a functional block diagram illustrating program components of a mobile device, in accordance with embodiments of the present invention.

FIG. 3 is a functional block diagram of mobile device, in accordance with embodiments of the present invention.

FIG. 4 is a functional block diagram illustrating program components of a computer, in accordance with embodiments of the present invention.

FIG. 5 is a flow diagram depicting steps performed by a mobile program for transmitting a notification, via mobile notification flags, of a missed call, or missed mobile message of a mobile device, in accordance with embodiments of the present invention.

FIG. 6 is a block diagram of components of a computer system, in accordance with embodiments of the present invention.

### DETAILED DESCRIPTION

Embodiments of the present invention comprise one or more circuits or subassemblies of circuits as well as methods of operation that are executed to notify a user of one or more computing devices of a missed call, or a missed mobile instant message of the one or more computing devices, when at least one of the one or more computing devices is idle, and when the user moves away, in a proximate distance, from the one or more computing devices.

According to at least one embodiment, the notification can also include, for example, a missed mobile or computing alert, or a missed mobile or computing alarm of the idled one or more computing devices. The at least one or more computing devices can be a primary device of the user. Further, the mobile instant message can be a short message service (SMS) of the one or more computing devices. For example, according to aspects of the present invention, short messaging, or SMS is a form of communication mode that is used in a mobile network for transmitting a plurality of mobile instant messages among computing devices, or mobile computing device.

According to at least one embodiment, the user of the one or more computing devices is notified of the missed call, or the missed mobile instant message of the at least one of the one or more computing devices that is idle, when the user returns proximately close to the one or more computing devices. For example, notification of the missed call or the missed mobile instant message becomes more aggressive over time, until the user acknowledges the notification. Also, notification of the missed call or the missed mobile instant message can also be transmitted to at least one or more alternative computing devices that are active, or actively used by the user, while the primary device of the user is idle, as described above.

For example, a system of the present invention can determine whether the one or more alternative computing devices are actively used by the user. Thereafter, the system can further transmit the notification to the one or more alternative computing devices that are actively used by the user. For example, according to one embodiment, the system of the present invention can transmit the notification to the alternative one or more computing devices, via a SMS, or mobile instant message of the primary device. Further, once the notification of the primary device is acknowledged, the notification can be transmitted, or synced back to the primary device that is idle.

At least one embodiment of the present invention also leverages the user's proximity of the at least one of the one or more computing devices that is idle, to trigger the notification. For example, the present invention is adapted to display an indication, including, for example, a brightly colored flag, or button that deploys, and protrudes from the top of the at least one of the one or more computing devices that is idle, to indicate notification of the missed call, or the missed mobile instant message. The nonfiction of the missed call can also include, for example, icons or flashing lights on a display of the one or more computing device that is idle, to indicate the notification.

The present invention, thus, provides, facilitation for ensuring that the user does not miss an important notification of the one or more computing devices, wherein the notifications includes, for example, a missed call, or a missed mobile instant message of the one or more computing devices. Further, the present invention also provides facilitation for immediately alerting, or notifying the user of the missed call, or the missed mobile instant message, as soon as the user is in proximity to the one or more computing devices of the missed call, or the missed mobile instant message, as described below, in accordance with embodiments of the present invention.

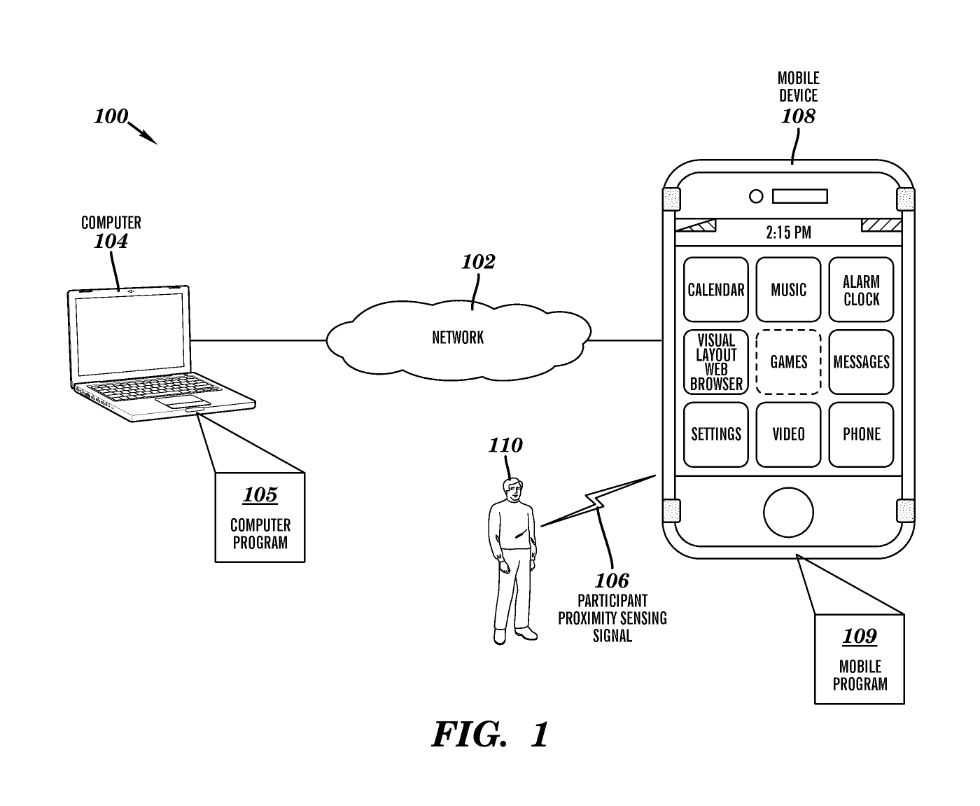

The present invention will now be described in detail with reference to the accompanying Figures. Referring now to FIG. 1, system notification environment 100 for notifying a user of one or more computing devices of a missed call, or a missed SMS message of the one or more computing devices, when at least one of the one or more computing devices is idle, is illustrated.

System notification environment 100 includes computer 104, network 102, and mobile device 108. According to one embodiment, computer 104 and mobile device 108 operate over network 102 to facilitate notification to user 110, of the missed call, or the missed mobile instant message. For example, mobile device 108 detects, via participant proximity sensing signal 106, if user 110 is in proximate distance to mobile device 108, which is idle. If user 110 is in proximate distance to mobile device 108, user 110 is notified of the missed call, or the missed instant message of mobile device 108.

The depicted embodiment can include additional computing devices, and additional users, engaged in notification of a missed call, or a missed mobile instant message of either one or more of computer 104 or mobile device 108, when at least one of computer 104 or mobile device 108 is idle, and user is in proximate distance to the idled computer 104 or mobile device 108. Further, roles of providing notification of a missed call, or a missed mobile instant message to user 110 can be interchangeable.

Mobile device 108 can be any portable device that provides computing, information storage and, computing retrieval capabilities, including, for example, a handheld device or handheld computer, pocket PC, connected organizer, electronic book (eBook) reader, a personal digital assistant (PDA), or a smart phone, or other portable devices. Mobile device 108 comprises mobile program 109.

Mobile program 109 provides mobile instant messaging service, short message servicing (SMS), or other mobile device services, including, for example, a text based instant message service, a voice based instant message service, or a video based instant message service. For example, utilizing a sensor detection program of mobile device 108, mobile program 109 provides a notification instant message service for notifying user 110 of a missed call, or SMS message of mobile device 108. Mobile program 109 is adapted to display an indication, including, for example, a brightly colored flag, or button that deploys, or protrudes from the top of mobile device 108, to indicate notification of the missed call, or the missed mobile instant message, as described. Notification of the missed call or the missed mobile instant message of mobile program 109 can also be transmitted to computer 104, which can be, for example, active, or actively used by user 110, in accordance with embodiments of the present invention.

Computer 104 is a laptop, tablet, or notebook personal computer (PC), a desktop computer, a mainframe or mini computer, or a personal digital assistant (PDA). Computer 104 comprises computer program 105. Computer program 105 provides an operating system platform for facilitating transmission of notification of a missed call or a missed mobile message of mobile device 108.

Network 102 includes one or more networks of any kind that can provide communication links between various devices and computers connected together within system notification environment 100. Network 102 can also be implemented as a number of different types of networks, including, for example, a local area network (LAN), wide area network (WAN) or a packet switched telephone network (PSTN), or some other networked system. For example, system notification environment 100 can utilize the Internet with network 102 representing a worldwide collection of networks. The term “Internet” as used according to embodiments of the present invention refers to a network or networks that uses certain protocols, such as the TCP/IP protocol, and possibly other protocols such as the hypertext transfer protocol (HTTP) for hypertext markup language (HTML) documents that make up the world wide Web (the web).

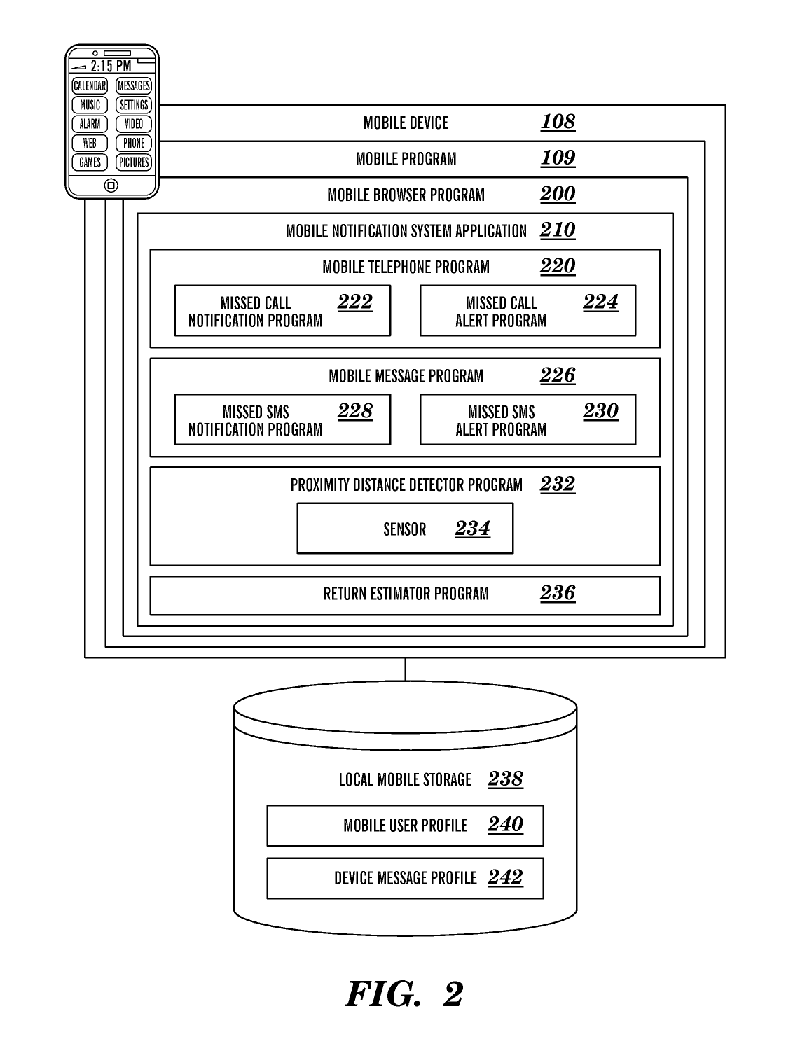

FIG. 2 is a functional block diagram illustrating program components of mobile device 108, in accordance with an embodiment of the present invention.

Mobile device 108 includes local mobile storage 238 and mobile program 109. Local mobile storage 238 can be any type of mobile database system that maintains information pertaining to mobile notification profile of user 110, for notifying user 110 of a missed call, or mobile instant message, of mobile device 108, when user 110 returns proximately close to mobile device 108.

Local mobile storage 238 includes mobile user profile 240 and device message profile 242. Local mobile storage 238 maintains a profile of credentials of user 110 in mobile user profile 240, wherein the credentials of mobile user profile 240 are utilized by mobile program 109 to identify user 110, and thus, notify user 110, via the notification service of mobile device 108, of a missed call, or a missed mobile message of mobile device 108, in accordance with embodiments of the present invention.

Mobile device 108 also maintains, in local mobile storage 228, device message profile 242. Device message profile 242 includes history, or record of mobile instant messages of user 110, wherein the stored history or record of the mobile instant messages can be utilized by mobile program 109 for notifying user 110 of a missed call, or a missed SMS message of mobile device 108. For example, the stored history, or record of the mobile instant messages can be utilized by mobile program 109 to calculate users' return time to mobile device 108, when mobile device 108 is idle.

Mobile program 109 can, among other things, retrieve and display, via network 102, web pages containing one or more instant message (IM) services, or mobile SMS services. Mobile program 109 also provides facilitation for transmitting telephone calls, SMS messages, or instant messaging services of mobile device 108, wherein the telephone calls, SMS message, or instant messaging can be transmitted between a plurality of individuals. For example, telephone calls, SMS messages, instant messaging services of mobile device 108, can be directed to a notification service of mobile program 109, with user 110, being identified with a username, or other authentication credentials for receiving the telephone calls, SMS messages, instant messaging services, based on credentials of user 110, which are stored in mobile user profile 240.

Mobile program 109 includes mobile browser program 200. Mobile browser program 200 is a mobile plug-in/add-on that extends the functionality of mobile program 109, by adding user interface elements to mobile program 109. For example, the user interface can, for example, provide a user interface display for notifying user 110 of a missed call, or a missed mobile instant message. Mobile browser program 200 includes mobile notification system application 210. Mobile notification system application 210 controls telephone call or mobile instant message notification services of mobile device 108. For example, the notification services of mobile device 108 can include, for example, telephone call services of incoming or outgoing telephone calls of mobile device 108, or mobile instant messaging service of mobile device 108.

Also, mobile notification system application 210 detects, via a proximity sensor, if user 110 is in proximate distance to mobile device 108. For example, when user 110 moves away from mobile device 108, mobile notification system 210 calculates user's 110 estimated return time to mobile device 108, wherein user 110 estimated return time is based on calendaring information, or system usage pattern of user 110 of mobile device 108. Mobile device notification system application 210 further intercepts an existing notification of mobile device 108. The existing notification is intercepted when user 110 moves away from mobile device 108. Also, the existing notification is suspended when the proximity sensor of mobile device 108 detects that user 110 is away, and not in a proximate distance from mobile device 108. Mobile notification system 210 intensifies a new, non-existing notification of the mobile device 108, based on the calculated estimated return time of users, and the detected proximate distance, when user 110 returns, within a proximate distance of mobile device 108.

Mobile notification system application 210 includes mobile telephone program 220, mobile message program 226, proximity distance detector program 232, and return estimator program 236. Mobile telephone program 220 sends or receives telephone calls of mobile device 108. For example, according to at least one embodiment, mobile telephone program 220 allows user 110 to send, or receive telephone calls of mobile device 108 over a radio link of network 102. Mobile telephone program 210 includes missed call notification program 222 and missed call alert program 224.

Missed call notification program 222 notifies user 110 of a missed call of mobile device 108 when the user returns, in proximate distance to mobile device 108. For example, missed call alert program 224 transmits a messaging alert within mobile device 108, for notifying user 110 of the missed call of mobile device 108. The messaging alert is a protruding flag, or button of mobile device 108, which is visible, and provides notification of the missed call, or missed mobile message.

Mobile message program 226 is an instant messaging service of mobile device 108. The instant messaging service of mobile device 108 includes a text messaging service, or a short messaging service (SMS). Mobile message program 226 includes missed SMS notification program 228 and missed SMS alert program 230.

Missed SMS notification program 228 notifies user 110 of a missed mobile message of mobile device 108. Missed SMS alert program 230 notifies user 110 of the missed mobile instant message of mobile device 108, when the user returns, in proximate distance to mobile device 108. Similarly, missed SMS alert program 230 transmits a messaging alert to mobile device 108, for notifying user 110 of the missed SMS of mobile device 108. Also, according to at least one embodiment, the messaging alert of missed SMS alert program 230 is a protruding flag, or button of mobile device 108.

Proximity distance detector program 232 detects, via sensor 234, when user 110 is in vicinity of mobile device 108, for example, within 10 feet of mobile device 108. According to at least one embodiment, proximity distance detector program 232 detects if user 110 is in proximate distance to mobile device 108 in an event that mobile notification system application 210 receives a missed call or a missed mobile message of missed call program or missed message program, respectively.

Sensor 234 is a motion detector that detects when user 110 returns to proximity close to mobile device 108. Sensor 234 can detect when user 110 returns to proximity close to mobile device 108 using a video camera, or motion device of mobile device 108. For example, sensor 234 transmits the detection of user 110 into an electrical signal, which is transmitted within mobile notification system application 210, for triggering a messaging alert, including, a protruding flag, or button of mobile notification system application 210, for alerting user 110 of a missed call or missed mobile message. Return time estimator calculates estimated return time of user 110 to mobile device 108, wherein, for example, users 110 estimated return times to the mobile device 108 can be based on calendaring information, or system usage pattern of user 110 of mobile device 108. For example, estimated return time of user 110 or usage pattern can be stored in mobile user profile 240 of local mobile storage 238. The stored estimated return time can further be utilized to support detection of presence of user 110, for triggering a messaging alert of the missed call or a missed mobile message.

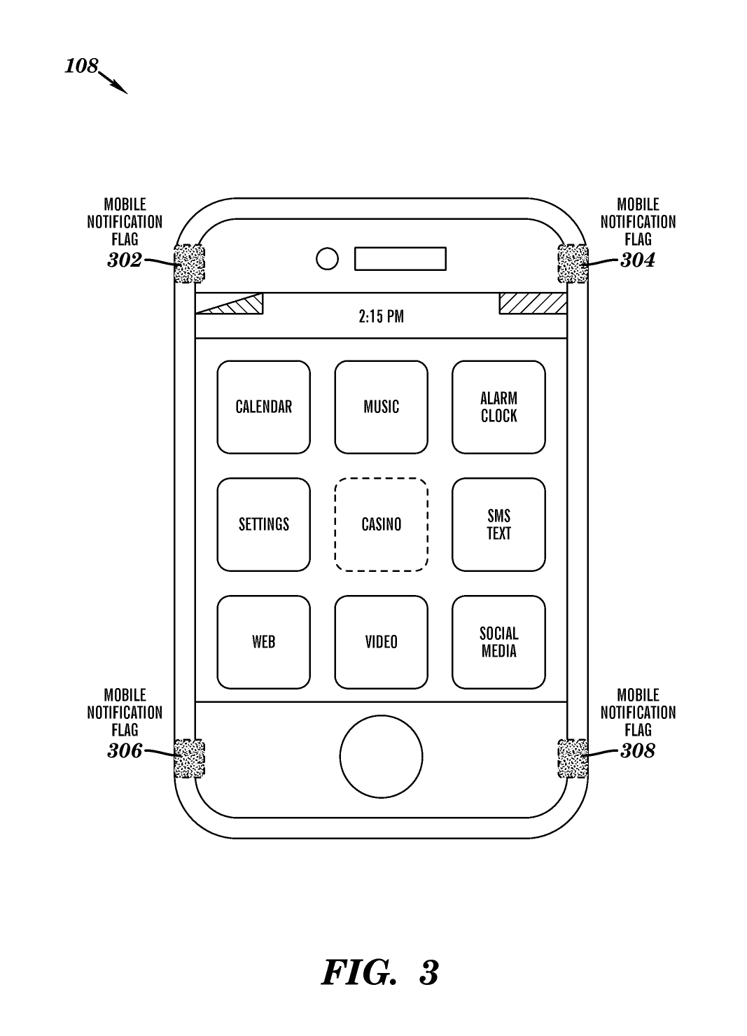

FIG. 3 is a functional diagram of mobile device 108, in accordance with embodiments of the present invention. In the depicted illustration, mobile device 108 can include various user interface displays for allowing user 110 to configure user settings for sending or receiving telephone calls or mobile instant messages of mobile device 108, in accordance with the present invention.

Mobile device 108 includes mobile notification flags 302, 304, 306, and 308. Notification flags 302, 304, 306, and 308 are visible on the exterior of mobile device 108. Notification flags 302, 304, 306, and 308 are messaging alerts, including, for example protruding flag, or button for notifying user 110 of a missed call or a missed mobile message of mobile device 108. For example, the notifications of a missed call or a missed mobile message of mobile notification flags 302, 304, 306, and 308 could become more aggressive over time, until user 110 has acknowledged the notifications.

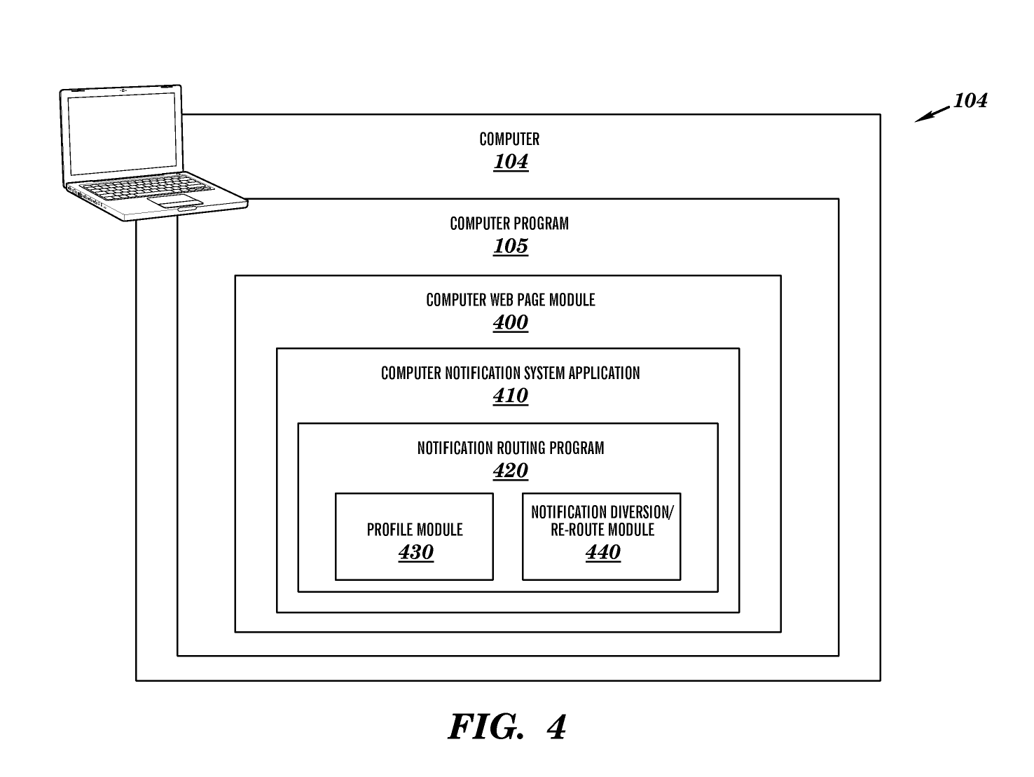

FIG. 4 is a functional block diagram depicting program components of computer 104, in accordance with the present invention. Computer 104 includes computer program 105. Computer program 105 provides an operating system platform for facilitating notification of a missed call or a missed mobile message of mobile device 108. For example, according to at least one embodiment, computer program 105 receives transmitted notifications of missed calls or missed mobile messages of mobile device 108, when mobile device 108 is idle, and user 110 is away from mobile device. Hence, in this case, notification of a missed call or a missed mobile message of mobile device 108 can be conveyed to user 110 via a notification service of computer program 105.

Computer program 105 includes computer web page module 400. Computer web page module 400 is a web plug-in/add-on that extends the functionality of computer program 105 by adding user interface elements to a user interface of computer program 105. For example, the additional user interface can, for example, allow facilitation of display of notifications of missed call, or missed mobile message of mobile device 108.

Computer web page module 400 includes computer notification system application 410. Computer notification system application 410 controls notification services of mobile device 108, wherein the notification services can be adapted to notify user 110, via notification routing program 420, of a missed call or missed mobile message of mobile device 108. Notification routing program 420 includes profile module 430 and notification diversion re-route module 440. Profile module 430 contains a profile of user 110, who, for example, is away from mobile device 108, and wherein notification of missed calls, or missed mobile messages of user 110 is transmitted to computer notification system application 410 by notification diversion re-router module 440, for display of the missed call, or the missed mobile message in computer 104.

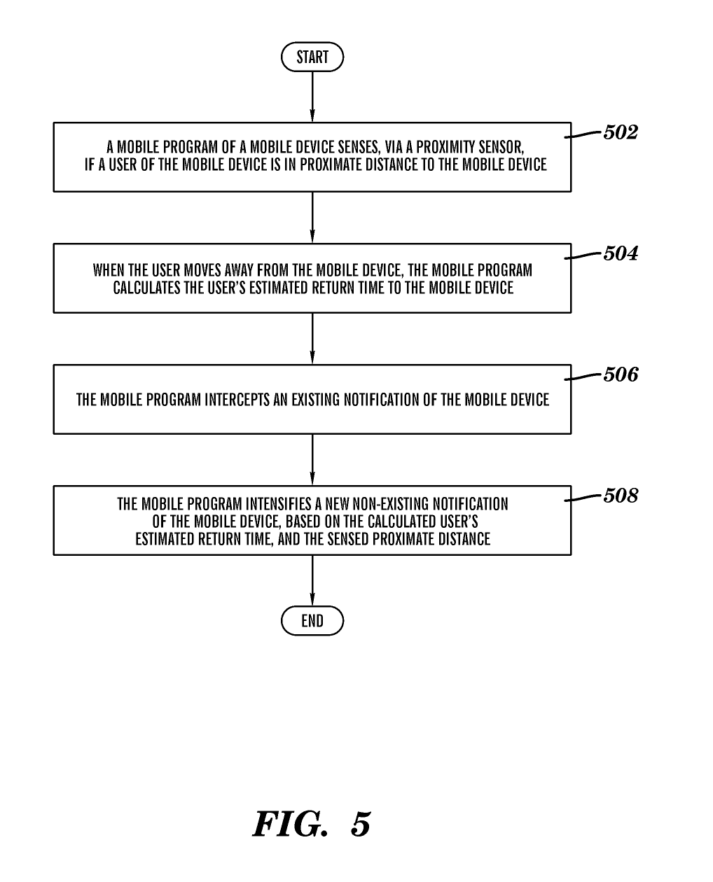

FIG. 5 is a flow diagram depicting steps performed by mobile program 109 for transmitting a notification, via mobile notification flags 302, 304, 306, and 308 of a missed call or missed mobile message of mobile device 108, when user 110 returns in proximate distance to mobile device 108, in accordance with embodiments of the present invention. Proximity distance detector program 232 of mobile program 109 detects, via sensor 234, if user 110 is in proximate distance to mobile device 108. (Step 502).

For instance, when if user 110 moves away from mobile device 108, mobile notification system application 210 of mobile program 109, calculates estimated return time of user 110 to mobile device 108, wherein the estimated return time of user 110 to mobile device 108, is based on calendaring information, or system usage pattern of the user 110 of mobile device 108. (Step 504).

Further, mobile notification system application 210, intercepts, for example, all existing notifications of mobile device 108 when user 100 is away from mobile device, and mobile device is idle. (Step 506). Mobile notification system application 210 intensifies a new, non-existing notification of mobile device, based on the calculated user's estimated return time, and the detected proximate distance of user. (Step 508). For example, once user returns in a proximate distance to mobile device 108, mobile program 109 can utilize user's estimated return time, and user's detected presence to trigger a new messaging alert, via, mobile notification flags 302, 304, 306, and 308 for alerting user 110 of a missed call or a missed mobile message of mobile device 108.

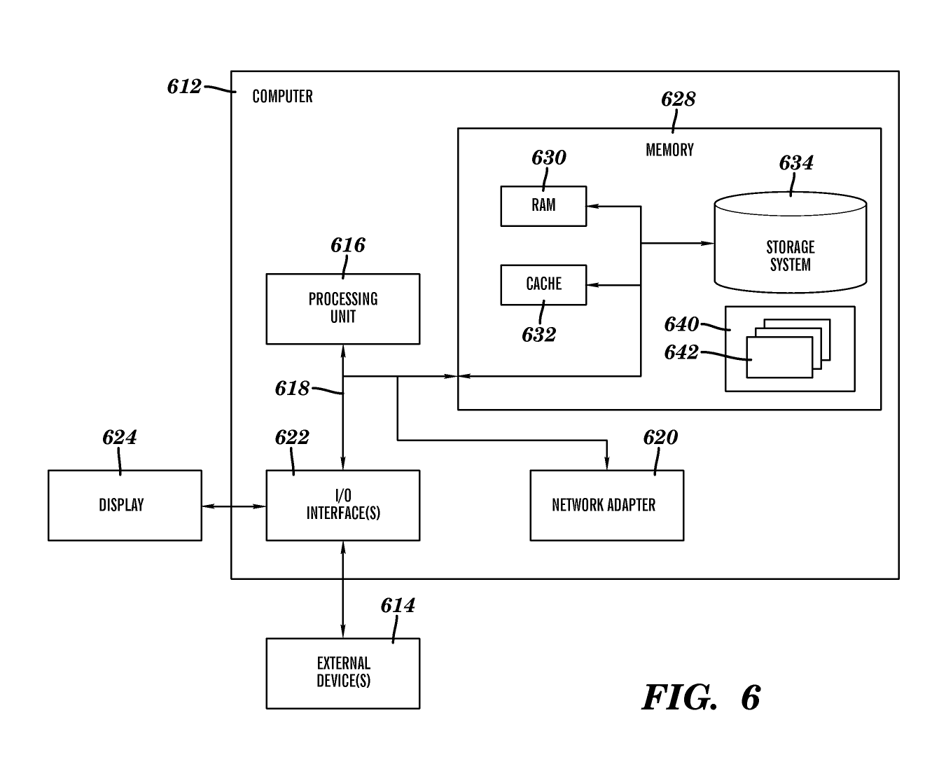

FIG. 6 is a functional block diagram of a computer system, in accordance with an embodiment of the present invention.

The Computer system of FIG. 6 is only one example of a suitable computer system and is not intended to suggest any limitation as to the scope of use or functionality of embodiments of the invention described herein. Regardless, the computer system is capable of being implemented and/or performing any of the functionality set forth hereinabove. In the computer system of FIG. 1, there is computer 612, which is operational with numerous other general purpose or special purpose computing system environments or configurations. Examples of well-known computing systems, environments, and/or configurations that may be suitable for use with computer 612 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Each one of mobile device 108 and computer 104 can be implemented as an instance of computer 612. Computer 612 may be described in the general context of computer system executable instructions, such as program modules, being executed by a computer system. Generally, program modules may include routines, programs, objects, components, logic, data structures, and so on that perform particular tasks or implement particular abstract data types. Computer 612 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 6, computer 612 is shown in the form of a general-purpose computing device. The components of computer 612 may include, but are not limited to, one or more processors or processing units 616, memory 628, and bus 618 that couples various system components including memory 628 to processing unit 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 612 typically includes a variety of computer system readable media. Such media may be any available media that is accessible by computer 612, and includes both volatile and non-volatile media, and removable and non-removable media.

Memory 628 includes computer system readable media in the form of volatile memory, such as random access memory (RAM) 630 and/or cache 632. Computer 612 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the invention.

Mobile program 109 and computer program 105 can be stored in memory 628 by way of example, and not limitation, as well as an operating system, one or more application programs, other program modules, and program data. Each of the operating system, one or more application programs, other program modules, and program data or some combination thereof, may include an implementation of a networking environment. Program modules 642 generally carry out the functions and/or methodologies of embodiments of the invention as described herein. Each one of mobile program 118, computer program 105, and records management server program 104 are implemented as or are an instance of program 640.

Computer 612 may also communicate with one or more external devices 614 such as a keyboard, a pointing device, etc., as well as display 624; one or more devices that enable a user to interact with computer 612; and/or any devices (e.g., network card, modem, etc.) that enable computer 612 to communicate with one or more other computing devices. Such communication occurs via Input/Output (I/O) interfaces 622. Still yet, computer 612 communicates with one or more networks such as a local area network (LAN), a general wide area network (WAN), and/or a public network (e.g., the Internet) via network adapter 620. As depicted, network adapter 620 communicates with the other components of computer 612 via bus 618. It should be understood that although not shown, other hardware and/or software components could be used in conjunction with computer 612. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains, or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for embodiments of the present invention may be written in any combination of one or more programming languages, including an object oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Based on the foregoing a method, system and computer program product method for system notification of a computing system has been disclosed. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A computer-implemented method for system notification of a computing system, the computer implemented method comprising:
detecting, by one or more processors, via a sensor, if a user of a computing system is in proximate distance to the computing system;
when the user moves away from the computing system, calculating, by the one or more processors, the user's estimated return time to the computing system, wherein the user's estimated return time to the computing system is based on calendaring information, or system usage pattern of the user of the computing system;
intercepting, by the one or more processors, an existing notification of the computing system, wherein the existing notification is intercepted when the user moves away from the computing system; and
intensifying, by the one or more processors, a new, non-existing notification of the computing system, based on the calculated user's estimated return time, and the detected proximate distance.

2. The computer-implemented method of claim 1, wherein the notification is a message alert, including at least one of: a missed call, a missed instant message, a missed alert, or a missed alarm of the computing system.

3. The computer-implemented method of claim 2, wherein the message alert is a protruding flag, button, or icons or flashing lights on a display of the of the computing system.

4. The computer-implemented method of claim 3, wherein the protruding flag, or button of the computing system is visible on the exterior of the computing system.

5. The computer-implemented method of claim 1, wherein the step of detecting, via a sensor, by one or more processors, if a user of a computing system is in proximate distance to the computing system, further comprises the steps of:
detecting, by one or more processors, when the user of the computing system is distanced from the computing system; and
detecting, by the one or more processors, the user's estimated return time to the computing system.

6. The computer-implemented method of claim 1, further comprising: transmitting, by the one or more processors, the notification of the computing system to an active alternative computing system of the user.

7. The computer-implemented method of claim 6, further comprising:
determining, by the one or more processors, whether the alternative computing system is actively used by the user; and
transmitting, by the one or more processors, the notification of the computing system to the alternative computing system, if it is determined that the alternative computing system is actively used by the user, wherein, once the notification of the alternative computing system is acknowledged, the notification is transmitted to the computing system.

8. A computer system for system notification of a computing system, the computer system comprises:
one or more processors, one or more computer-readable memories, one or more computer-readable tangible storage devices and program instructions which are stored on at least one of the one or more storage devices for execution by at least one of the one or more processors via at least one of the one or more computer readable memories, the program instructions comprising:
program instructions to detect, via a sensor, if a user of a computing system is in proximate distance to the computing system;
program instructions to calculate the user's estimated return time to the computing system, when the user moves away from the computing system, wherein the user's estimated return time to the computing system is based on calendaring information, or system usage pattern of the user of the computing system;
program instructions to intercept an existing notification of the computing system, wherein the existing notification is intercepted when the user moves away from the computing system; and
program instruction to intensify a new, non-existing notification of the computing system, based on the calculated user's estimated return time, and the detected proximate distance.

9. The computing system of claim 8, wherein the notification is a message alert of at least one of a missed call, a missed instant message, a missed alert, or a missed alarm of the computing system.

10. The computing system of claim 9, wherein the message alert is a protruding flag, button, or icons or flashing lights on a display of the of the computing system.

11. The computer system of claim 10, wherein the protruding flag, or button of the computing system is visible on the exterior of the computing system.

12. The computer system of claim 8, wherein program instructions to detect, via a sensor if a user of a computing system is in proximate distance to the computing system, further includes:
program instructions to detect when the user of the computing system is distanced from the computing system; and
program instructions to detect the user's estimated return time to the distanced computing system.

13. The computer system of claim 8, wherein the notification is intensified until the notification is acknowledged by the user.

14. The computer system of claim 8 further includes:
program instructions to determine whether the alternative computing system is actively used by the user; and
program instructions to transmit the notification of the computing system to the alternative computing system, if it is determined that the alternative computing system is actively used by the user, wherein, once the notification of the alternative computing system is acknowledged, the notification is transmitted to the computing system.

15. A computer program product for system notification of a computing system, the computer program product comprises:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to detect, via a sensor, if a user of a computing system is in proximate distance to the computing system;
program instructions to calculate the user's estimated return time to the computing system, when the user moves away from the computing system, wherein the user's estimated return time to the computing system is based on calendaring information, or system usage pattern of the user of the computing system;
program instructions to intercept an existing notification of the computing system, wherein the existing notification is intercepted when the user moves away from the computing system; and
program instruction to intensify a new, non-existing notification of the computing system, based on the calculated user's estimated return time, and the detected proximate distance.

16. The computer program product of claim 15, wherein the notification is a message alert, including at least one of: a missed call, a missed instant message, a missed alert, or a missed alarm of the computing system.

17. The computer program product of claim 16, wherein the message alert is a protruding flag, button, or icons or flashing lights on a display of the of the computing system.

18. The computer program product of claim 17, wherein the message alert does not require the computing system to be lit.

19. The computer program product of claim 15, wherein program instructions to detect, via a sensor if a user of a computing system is in proximate distance to the computing system, further includes:
program instructions to detect when the user of the computing system is distanced from the computing system; and
program instructions to detect the user's estimated return time to the distanced computing system.

20. The computer system of claim 8 further includes:
program instructions to determine whether the alternative computing system is actively used by the user; and
program instructions to transmit the notification of the computing system to the alternative computing system, if it is determined that the alternative computing system is actively used by the user, wherein, once the notification of the alternative computing system is acknowledged, the notification is transmitted to the computing system.
